(19) United States
(12) Patent Application Publication
(10) Pub. No.: US 2002/0130207 A1
(43) Pub. Date: Sep. 19, 2002

(54) Unmanned vehicle adapted to be used in a stable

(75) Inventor: Karel van den Berg, Bleskensgraaf (NL)

Correspondence Address: Penrose Lucas Albright, Esq., MASON, MASON & ALBRIGHT, P.O. Box 2246, Arlington, VA, 22202-0246, US

(73) Assignee: LELY RESEARCH HOLDING A.G., a Swiss limited liability Company

(21) Appl. No.: 09/768,438

(22) Filed: Jan. 25, 2001

Related U.S. Application Data
(63) Continuation of application No. PCT/NL00/00311, filed on May 10, 2000.

(30) Foreign Application Priority Data
May 25, 1999 (NL) 1012140

(51) Int. Cl. A01C 15/04

(52) U.S. Cl. 239/654; 239/67; 239/73; 239/172; 239/662

(57) ABSTRACT

An unmanned vehicle for use in a stable such as a shed for dairy cattle is provided with a hopper and spreader for carrying and distributing a material such as sawdust or straw on the floor of a stable. The spreader components comprise a venturi-type meter for determining the rate that material is to be spread; a blower and an air compressor to provide air stream which entrains and carries the sawdust or straw to its distribution area; a distribution mouthpiece to provide for uniform spreading of the material; a detection device including a camera for determining the surface area to be covered; navigation apparatus for steering which also includes the camera; and a manure displacer which is carried by the vehicle.

### RELATED APPLICATION

This Application is a Continuation of International Application No. PCT/NL00/00311, filed May 10, 2000.

### FIELD OF INVENTION

The invention relates to an unmanned vehicle for spreading sawdust or straw in a stable, such as is used for dairy cattle.

### BACKGROUND OF THE INVENTION

Unmanned vehicles for use in stables are usually employed for cleaning the stable floor.

### SUMMARY OF THE INVENTION

An object of the instant invention is to provide a multifunctional, unmanned vehicle for spreading sawdust or straw in a stable.

In accordance with the invention, this is achieved by providing a hopper which is connected to an unmanned vehicle or providing an unmanned vehicle which comprises a hopper for the storage of material, which further comprises a spreading means for spreading material, such as sawdust or straw. The unmanned vehicle is therefore capable of spreading a layer of sawdust or straw or any other material which is suitable for covering a floor, such as that of a cubicle in the stable. According to an inventive feature, the spreading means comprises metering means for metering the material to be spread. The metering means thus spreads a uniform layer of material over certain floor surface areas in the stable. According to an embodiment of the invention, the spreading means comprises a blower or ventilator device for spreading the material by moving and blowing it by means of an airstream. The spreading may also comprise a compressed air unit, so that the material is spread by means of a stream of compressed air. According to an inventive feature the spreading means comprises a distribution mouthpiece for spreading material uniformly over a specific surface area. The spread pattern of the material is exactly defined by the distribution mouthpiece. According to another inventive feature, the spreading means on the unmanned vehicle is rotatable for spreading in a more flexible manner.

According to again another inventive feature, the unmanned vehicle comprises a navigation means for guiding the unmanned vehicle through the stable. According to a further inventive feature, the unmanned vehicle comprises detection means for determining the surface area to be covered with the material to be spread. According to an aspect of the invention, the navigation means or detection means, or both, comprise a camera. However, the navigation means may comprise, in addition to the camera, a radar or an ultrasonic sensor, for example. Detection means other than those already mentioned and alternative sensors may be used as well.

According to an inventive feature, the unmanned vehicle may also comprise a manure displacing device, such as a manure slide. The displacing device first cleans a cubicle, after which the material to be spread such as straw or sawdust is distributed over the cubicle floor.

### BRIEF DESCRIPTION OF THE DRAWINGS

The invention will now be explained in further detail with reference to the accompanying drawings.

FIG. 1 is an elevational side view of a first embodiment of an unmanned vehicle according to the invention; and

FIG. 2 is an elevational side view of a second embodiment of an unmanned vehicle according to the invention.

### DETAILED DESCRIPTION OF THE PREFERRED EMBODIMENTS:

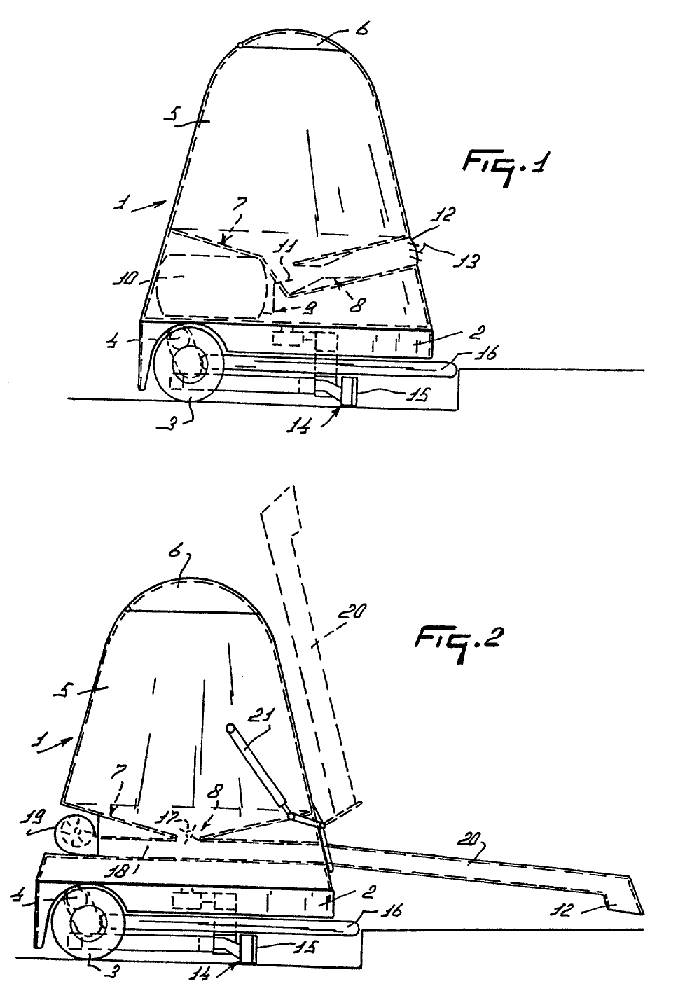

FIG. 1 shows a first embodiment of an unmanned vehicle 1 comprising a frame 2 with two wheels 3 disposed thereunder. Wheels 3 are each individually drivable by means of a corresponding electrical motor 4. Arranged on frame 2 is a hopper 5 having a cover 6. Hopper 5 has a generally conical configuration. In the lower side of hopper 5, are disposed spreading means 7. Material stored in hopper 5, such as sawdust or straw, can thus be spread over the stable floor. Spreading means 7 comprises a metering unit 8 which, in the present embodiment, is designed as a venturi. Spreading means 7 further comprises a compressed air unit 9 comprising a compressed air vessel 10 with a pipe 11 connected thereto. A valve enables air to flow from the compressed air vessel via pipe 11 to metering unit 8. Material to be spread leaves metering unit 8 via a distribution mouthpiece 12. The distribution mouthpiece 12 comprises guide members 13 which are adjustable for directing the material to be spread.

The unmanned vehicle 1 is supported by wheels 3, and a further support point is comprised by a manure displacing device 14. In the present embodiment, the manure displacing device 14 comprises a manure slide 15. The unmanned vehicle 1 further comprises a rotatable guide or protective bracket 16.

FIG. 2 shows a second embodiment of an unmanned vehicle 1, in which parts corresponding to those in the first embodiment are indicated by the same reference numerals. In the second embodiment of the invention, spreading means 7 comprises a metering unit 8 which comprises a cam wheel 17. Spreading means 7 further comprises a guide channel 18, one end of which is connected to venitilator 19. Ventilator 19 blows air into guide channel 18. Cam wheel 17 brings material from hopper 5 into guide channel 18. The other end of guide channel 18 is connected to an extension piece 20 the end of which comprises a distribution mouthpiece 12. Extension piece 20 can be pivoted upwards by means of a control cylinder 21, as shown in FIG. 2.

Both in the first and second embodiment of the invention it is possible to rotate spreading means 7 relative to the frame 2 with the aid of control means.

Although I have disclosed the preferred embodiments of my invention, it is to be understood that it is capable of other adaptation and modifications within the scope of the following claims.

11. An automated system for spreading material on floor which comprises an unmanned vehicle that moves along said floor, guidance means for controlling the movement of said vehicle on such floor, a hopper for storing said material operatively associated with said vehicle, and spreading means for spreading said material which it receives from said hopper onto said floor.

12. A system in accordance with claim 11 wherein said hopper is attached to said vehicle.

13. A system in accordance with claim 12, wherein said vehicle comprises a metering means for metering said material.

14. A system in accordance with claim 13, wherein said metering means comprises a venturi-type device.

15. A system in accordance with claim 14, wherein said spreading means comprises a blower.

16. A system in accordance with claim 14, wherein said spreading means comprises an air compressor.

17. A system in accordance with claim 11, wherein said spreading means comprises a distribution mouthpiece for directing the spreading of said material.

18. A system in accordance with claim 11, wherein said spreading means further comprises a rotating means that rotates said spreading means independently of said vehicle.

19. A system in accordance with claim 11 , which comprises navigation means for steering the unmanned vehicle in said stable.

20. A system in accordance with claim 19, wherein said navigation means comprises a camera.

21. A system in accordance with claim 11, which comprises a detection means for determining the surface area to be covered by said material which is to be spread.

22. A system in accordance with claim 21, wherein detection means comprises a camera.

23. A system in accordance with claim 11, wherein said vehicle comprises a manure displacer.

24. A system for automated spreading of an absorbent divided material on a stable floor which comprises an unmanned vehicle, guidance means including a camera for controlling the movement of said vehicle on said floor, a hopper carrying said material on said vehicle, manure displacement means on said vehicle, compressed air means on said vehicle which creates a stream of air into which said material is adjustably entrained by a venturi effect, and directing means for directing the flow of said stream of air with said material entrained therein to areas of said floor which have been selected with the aid of said camera.

25. A system in accordance with claim 24 wherein said material is composed of sawdust.

26. A system in accordance with claim 24, wherein said material is composed of straw.
